(19) United States
(12) Patent Application Publication
(10) Pub. No.: US 2025/0054003 A1
(43) Pub. Date: Feb. 13, 2025

(54) COMPUTER IMPLEMENTED METHODS AND COMPUTER SYSTEMS FOR AUTOMATING MARKET RESEARCH USING ARTIFICIAL INTELLIGENCE AGENTS

(71) Applicant: ProAl, Inc., San Francisco, CA (US)

(72) Inventor: Chase Hughes, Crawfordsville, IN (US)

(73) Assignee: ProAI, Inc., San Francisco, CA (US)

(21) Appl. No.: 18/673,378

(22) Filed: May 24, 2024

Related U.S. Application Data
(60) Provisional application No. 63/518,335, filed on Aug. 9, 2023.

(51) Int. Cl. G06Q 30/0202; G06Q 10/0637; G06Q 30/0201; G06Q 30/0203; G06Q 30/0204

(52) U.S. Cl. CPC G06Q 30/0202; G06Q 10/0637; G06Q 30/0203; G06Q 30/0204; G06Q 30/0206

(57) ABSTRACT

A computer-implemented method and a computer system for automating market research is disclosed. The computer-implemented method includes receiving a query from a user within a Market Research System (MRS). Collecting context relevant to the query based on availability of internal information retrieval by querying the user with one or more clarification questions using one or more Artificial Intelligence (AI) agents. Forming a strategy to retrieve data from available data sources based on the context. Retrieving data from the available data sources based on the strategy. Analysing the data to determine if the retrieved data is sufficient to complete the research objective. Requesting modification or additional information in the data, responsive to the data not being determined as sufficient to complete the research objective. Determining market research parameters based on the analysed data. Iteratively optimizing market research parameters by activating the one or more AI agents.

### TECHNICAL FIELD

The present invention relates to Artificial Intelligence (AI) based automation of research processes. More specifically, the present invention relates to the automated market research by leveraging several Artificial Intelligence (AI) agents interacting with each other.

### BACKGROUND ART

Entrepreneurs and businessmen often solicit the services of consulting firms to kick-start, run, expand (by adding new verticals), and monetize their businesses. Such services include market research. However, such services have some key limitations. The costs of hiring consulting firms are often prohibitively expensive for many businesses, especially smaller companies, or startups. The typical model of parachuting in external consultants can face challenges in implementing changes, as organizational inertia and resistance frequently hamper progress. Employees accustomed to legacy processes are slow to adopt radically new ways of operating. Further, the siloed nature of consulting projects often fails to translate into enterprise-wide transformation.

However, such services are provided by a handful of organizations specialized in the business consulting space and generally involve large amounts of costs to be paid by the business owners. Such costs are not always affordable to many small businesses and start-ups that have not managed to successfully arrange for sufficient funding through their investors. Moreover, there exists large language model-based methods of market research. The problem with current large language model-based methods of market research lies in their heavy reliance on secondhand data and the methods used to gather it. These methods typically involve querying search engines, scraping website data, and then organizing it for user consumption. However, this approach suffers from several significant drawbacks.

Firstly, the reliability of the information obtained through search engines and website scraping is questionable. Much of the data available on search engines is susceptible to manipulation or inaccuracies. This is because search engine algorithms prioritize certain types of content based on various factors such as popularity, relevance, and the website's authority. As a result, the data retrieved may not accurately reflect the true sentiments or preferences of the target audience.

Secondly, the sources of the data and the methodologies used to collect it are often opaque. Many search engines and websites do not disclose the specifics of their data collection processes or the criteria used to rank search results. Without this transparency, it's challenging for researchers to assess the reliability and validity of the data they're using for analysis. This lack of transparency also raises questions about the potential biases inherent in the data, which can further undermine the accuracy of market research findings. Overall, relying solely on secondhand data gathered through search engines and website scraping poses significant limitations for market research.

Therefore, there is a need in the art for computer-implemented methods and computer systems for automating market research that that prioritize transparency, data integrity, and robust through seamless integration with the disclosed computer-implemented methods to ensure more accurate and reliable insights into consumer behavior and market trends.

However, such services are provided by a handful of organizations specialized in the business consulting space and generally involve large amounts of costs to be paid by the business owners. Such costs are not always affordable to many small businesses and start-ups that have not managed to successfully arrange for sufficient funding through their investors. Moreover, there exists large language model-based methods of market research. The problem with current large language model-based methods of market research lies in their heavy reliance on secondhand data and the methods used to gather it. These methods typically involve querying search engines, scraping website data, and then organizing it for user consumption. However, this approach suffers from several significant drawbacks.

Firstly, the reliability of the information obtained through search engines and website scraping is questionable. Much of the data available on search engines is susceptible to manipulation or inaccuracies. This is because search engine algorithms prioritize certain types of content based on various factors such as popularity, relevance, and the website's authority. As a result, the data retrieved may not accurately reflect the true sentiments or preferences of the target audience.

Secondly, the sources of the data and the methodologies used to collect it are often opaque. Many search engines and websites do not disclose the specifics of their data collection processes or the criteria used to rank search results. Without this transparency, it's challenging for researchers to assess the reliability and validity of the data they're using for analysis. This lack of transparency also raises questions about the potential biases inherent in the data, which can further undermine the accuracy of market research findings. Overall, relying solely on secondhand data gathered through search engines and website scraping poses significant limitations for market research.

### OBJECTS OF THE INVENTION

Some of the objects of the invention are as follows:

An object of the present invention is to provide computer-implemented methods and computer systems that leverage interactions of several Artificial Intelligence (AI) agents to generate documentation related to several different aspects of market research.

Another object of the present invention is to provide computer-implemented methods and computer systems that can access information and databases that are available through several different sources during the market research.

Another object of the present invention is to provide computer-implemented methods and computer systems that allow integration of currently available and widely implemented market research solutions as data sources for the training of AI agents.

Another object of the present invention is to provide computer-implemented methods and computer systems that allow users to upload data through sources such as the Internet or memory drives, where the uploaded data may then be used to train the AI agents and/or generate market research documentation.

Another object of the present invention is to provide computer-implemented methods and computer systems that allow the integration of custom-built coded features that are capable of addressing deficiencies of currently available AI agents.

Another object of the present invention is to provide computer-implemented methods and computer systems that can generate several market research pertinent deliverables in user-readable formats enabling quick implementation of market strategies based on market research.

It is also an object of the present invention to provide computer-implemented methods and computer systems that allow the translation of information from one user-readable format to another user-readable format while maintaining the integrity and completeness of the information.

### SUMMARY OF THE INVENTION

According to a first aspect of the present invention, there is provided a computer-implemented method for automating market research using artificial intelligence agents. The computer-implemented method includes receiving a query from a user within a Market Research System (MRS). The query comprises a standard report, a research objective and/or one or more questions. The computer-implemented method further includes collecting context relevant to the query based on availability of internal information retrieval by querying the user with one or more clarification questions using one or more Artificial Intelligence (AI) agents within the MRS. The computer-implemented method further includes forming a strategy to retrieve data from available data sources based on the context. The strategy formation includes determining reliability of the available data sources and prioritizing the available data sources according to relevance of the available data sources for the research objective. The available data sources comprising non-agent sources such as web scrapping, Application Programming Interface (API) endpoints, web browsing, and uploaded files, as well as agent-based sources such a synthetic focus groups, synthetic surveys, and autonomous survey collection. The computer-implemented method further includes retrieving data from the available data sources based on the strategy. The computer-implemented method further includes analysing the data to determine if the retrieved data is sufficient to complete the research objective. The computer-implemented method further includes requesting modification or additional information in the data based on the analysis using the one or more AI agents within the MRS, responsive to the data not being determined as sufficient to complete the research objective. The computer-implemented method further includes determining market research parameters based on the analysed data to the user. The market research parameters comprising dynamic reports with visualizations and/or structured reports based on predefined templates. The computer-implemented method further includes iteratively optimizing market research parameters by activating the one or more agents within the MRS based on incoming data and feedback. In one embodiment of the invention, the internal information retrieval includes simulating user personas and gathering insights into user preferences and behaviors.

In one embodiment of the invention, if the internal information retrieval is available, the clarification questions are provided to gather additional details to refine the research, and if the internal information retrieval is not available, the clarification questions are provided to establish a baseline of the context.

In one embodiment of the invention, the computer-implemented method further includes adjusting the strategy formation based on feedback received from the user.

In one embodiment of the invention, the context relevant to the query includes information about the user including target demographics, company goals, pricing strategies, and product features.

In one embodiment of the invention, the computer-implemented method further includes displaying the market research parameters including the dynamic reports with the visualizations including the charts, the graphs, and the tables to convey the analysed data.

In one embodiment of the invention, the optimization of the market research parameters includes iteratively finetuning the one or more AI agents within the MRS based on the data, user feedback, and predefined optimization criteria.

In one embodiment of the invention, the structured reports provided to the user are generated based on predefined templates utilizing the one or more AI agents within the MRS to fill in relevant data and analysis.

According to a second aspect of the present invention, there is provided a computer system for automating market research. The computer system includes a memory unit configured to store machine-readable instructions and a processor operably connected to the memory unit. The processor is configured to execute the machine-readable instructions, that when executed, enable the processor to receive a query from a user. The query includes a standard report, a research objective and/or one or more questions. The processor is further enabled to collect context relevant to the query based on availability of internal information retrieval by querying the user with one or more clarification questions from the user using one or more Artificial Intelligence (AI) agents. The processor is further enabled to form a strategy to retrieve data based on available data sources based on the context. The strategy formation includes determining reliability of the available data sources and prioritizing the available data sources according to their relevance of the available data sources for the research objective. The processor is further enabled to retrieve data from the available data sources based on the strategy. The available data sources include non-agent sources such as web scrapping, Application Programming Interface (API) endpoints, web browsing, and uploaded files, as well as agent-based sources such as synthetic focus groups, synthetic surveys, and autonomous survey collection. The processor is further enabled to analyse the data to determine if the retrieved data is sufficient to complete the research objective. The processor is further enabled to request modification or additional information in the data based on the analysis using the one or more AI agents within the MRS, responsive to the data not being determined as sufficient to complete the research objective. The processor is further enabled to determine market research parameters based on the analysed data. The market research parameters include dynamic reports with visualizations and/or structured reports based on predefined templates. The processor is further enabled to iteratively optimize market research parameters by activating the one or more agents within the MRS based on incoming data and feedback.

In one embodiment of the invention, for the internal information retrieval, the processor is enabled to simulate user personas and gather insights into user preferences and behaviors.

In one embodiment of the invention, if the internal information retrieval is available, the clarification questions are provided to gather additional details to refine the research, and wherein if the internal information retrieval is not available, the clarification question are provided to establish a baseline of the context.

In one embodiment of the invention, the processor is further enabled to adjust the strategy formation based on feedback received from the user.

In one embodiment of the invention, the context relevant to the query includes information about the user including target demographics, company goals, pricing strategies, and product features.

In one embodiment of the invention, the processor is further enabled to display the market research parameters including the dynamic reports with the visualizations including the charts, the graphs, and the tables to convey the analysed data.

In one embodiment of the invention, to optimize the market research parameters, the processor is further enabled to iteratively finetune the one or more AI agents within the MRS based on the data, user feedback, and predefined optimization criteria.

In one embodiment of the invention, the structured reports provided to the user are generated based on predefined templates utilizing the one or more AI agents within the MRS to fill in relevant data and analysis.

According to a third aspect of the present invention, there is provided a non-transitory computer-readable storage medium storing computer-executable instructions which when executed by a computer system causes the computer system to receive a query from a user. The query includes a standard report, a research objective and/or one or more questions. The computer-executable instructions are further enabled to collect context relevant to the query based on availability of internal information retrieval by querying the user with one or more clarification questions from the user using one or more Artificial Intelligence (AI) agents. The computer-executable instructions are further enabled to form a strategy to retrieve data based on available data sources based on the context. The strategy formation includes determining reliability of the available data sources and prioritizing the available data sources according to their relevance of the available data sources for the research objective. The computer-executable instructions further enabled to retrieve data from the available data sources based on the strategy. The available data sources include non-agent sources such as web scrapping, Application Programming Interface (API) endpoints, web browsing, and uploaded files, as well as agent-based sources such as synthetic focus groups, synthetic surveys, and autonomous survey collection. The computer-executable instructions are further enabled to analyse the data to determine if the retrieved data is sufficient to complete the research objective. The computer-executable instructions are further enabled to request modification or additional information in the data based on the analysis using the one or more AI agents within the MRS, responsive to the data not being determined as sufficient to complete the research objective. The computer-executable instructions further enabled to determine market research parameters based on the analysed data. The market research parameters include dynamic reports with visualizations and/or structured reports based on predefined templates. The computer-executable instructions are further enabled to iteratively optimize market research parameters by activating the one or more agents within the MRS based on incoming data and feedback.

The present invention provides an end-to-end automated solution for generating market research deliverables that are more affordable, faster to implement, and easier to integrate than existing consulting approaches. By leveraging AI agents to automate workflows associated with tasks like market research, the system significantly reduces the need for expensive human consultants. Tasks that previously required weeks of manual effort by teams of analysts can now be accomplished in days or hours. The automated deliverables can be generated on demand for a fraction of the cost of traditional consulting. Further, the system seamlessly integrates with a client's existing data and processes, ensuring a smooth transition rather than major disruptions. The modular architecture based on combining specialized AI agents allows customized solutions to be efficiently created for clients across industries and business models. The result is a management consulting solution that breaks down cost and speed barriers while enabling businesses to get expert advice that fits their unique needs and constraints.

In the context of the specification, the phrase “Sequential Query Language (SQL) database” refers to a relational database system for storing and managing structured data. The data is stored in the form of tables and the tables may be correlated with each other with relationships. The data stored in the SQL database may be searched, updated, filtered, and deleted using Sequential Query Language.

In the context of the specification, the phrase “vector database” refers to a system of storing data in the form of multi-dimensional numerical vectors, where each dimension represents a feature or a characteristic of the data. The vectors may be created using several techniques such as embedding which transforms complex data like text, images, or audio into numerical representations.

In the context of the specification, the phrase “Artificial Intelligence (AI) agent” refers to an autonomously acting computer program designed to perceive its environment, make decisions, and take actions to achieve a goal or a set of goals. The AI agents may further be equipped with data-gathering and learning (reinforcement learning, supervised learning, or unsupervised learning) capabilities.

In the context of the specification, the phrase “Large Learning Model (LLM) agent” refers to AI agents that use deep learning techniques to understand, generate, and manipulate human language. LLM agents are trained on relatively large amounts of data that allow them to identify complex patterns and relationships between words. LLM agents are generally equipped with several capabilities such as Natural Language Processing (NLP), Text Generation, Question Answering, Dialogue, and Summarization.

In the context of the specification, the phrase “user-proxy agent” refers to an LLM agent that acts as an interface between a user and several other LLM agents. The user-proxy agents are configured to perform several tasks such as clarifying ambiguous queries, contextualizing requests, and preparing data in response to queries received from the user. Furthermore, the user-proxy agents may interpret responses, run generated code, and present results to the user. Additionally, the user-proxy agents may receive feedback from the user to improve and personalize the results generated by the LLM agent.

In the context of the specification, the phrase “communication bus” refers to a software-implemented platform that allows two or more AI agents and other coded programs to communicate with each other exchanging data as per pre-defined data exchange protocols.

In the context of the specification, the phrase “few-shot learning” refers to the training of machine learning models from a limited amount of data. The few-shot learning may be approached in several ways such as meta-learning (allowing machine learning models to apply previous learning experiences to new tasks), data augmentation (artificially expanding available data by creating new examples based on existing ones), few-shot optimization (optimizing parameters specifically for the few-shot learning scenario). Few-shot learning techniques offer several advantages such as quick adoption of new tasks, reduced data requirements, improved performance on small datasets, and increased AI capabilities. More information on few-shot learning can be found in web publications arXiv:2005.14165v4 and arXiv:2203.04291v1 which are incorporated herein by reference, in their entirety.

In the context of the specification, the phrase “web scraper agent” also referred to as “web harvester” or “web data extractor” refers to a program used for automatically collecting and extracting data from websites and web pages. The web scraper agents work by mimicking human users, navigating websites, and extracting specific pieces of information based on predefined rules.

In the context of the specification, the phrase “AI assistant retrieval agent” refers to a software program tool that enhances the capabilities of an AI assistant by incorporating external knowledge sources beyond an inherent model of the AI assistant. The AI assistant retrieval agent acts as a bridge between the assistant and several external information sources, allowing the AI assistant to access and process information that resides outside the data on which the AI assistant was originally trained.

In the context of the specification, the phrase “Retrieval Augmented Generation (RAG) Agent” refers to a software program that combines retrieval of information from external knowledge sources such as text documents, websites, databases, or other structured information repositories and generation of text that is contextually relevant and informative, using the retrieved information as a basis or reference. More information on RAG agents can be found in web publications arXiv:2005.11401v4 and arXiv:2312.10997v4 which are incorporated herein by reference, in their entirety.

In the context of the specification, the phrase “visual web browsing agent” refers to a computer-implemented software that is capable of browsing through a large number of web pages and is capable of analyzing visual components, such as images, videos, and layouts, present in the web pages. In that regard, visual web browsing agents are capable of extracting visual elements and metadata from images and videos, identifying layouts and structures of web pages, and comparing visual elements of different pages to identify similarities and trends. More information on visual web browsing agents can be found in the web publication arXiv:2305.11854v2 which is included herein by reference, in its entirety.

In the context of the specification, the phrase “JavaScript Object Notation (JSON)” refers to a format used for storing and exchanging structured data. It is based on JavaScript Object syntax but is language independent. A JSON object can contain data represented as key-value pairs, nested objects, and arrays, and written as plain text.

In the context of the specification, the phrase “JSON library” refers to a collection of code designed to help program developers work with JSON data in their programs. The JSON libraries help the developers in parsing, generating, manipulating, validating, encoding, and decoding JSON data.

In the context of the specification, the phrase “Application Program Interface (API) server” refers to a software program or a computing device that hosts the software program that allows two or more applications to communicate with each other and exchange data and information. In that regard, the API server may be configured to perform several tasks such as (1) translating a request from a source application into a format that is compatible with a destination application, (2) security verification of the source application, for example, by checking IP address, geographical location, ports and channels used, authorization credentials of the source device, etc. (3) protocol verification of the message, such as verification of encryption methodology followed, (4) transmittal of the translated request to the destination application, (5) receive the requested data from the destination application, (6) translate the received data into a format that is compatible with the source application, and (7) transmit the data to the source application over a communication network.

In the context of the specification, the phrase “web server” refers to a computer system or an executable segment of machine-readable code that allows communication with client systems (such as a web browser or a standalone computer application) using the Hypertext Transfer Protocol (HTTP), a set of rules that define how web servers and clients exchange information. When a user types a URL into a web browser (acting as a client), the browser sends an HTTP request to the web server that hosts the website. The web server then processes the request and sends back an HTTP response that contains the requested content.

In the context of the specification, the term “firewall” refers to a network security device that monitors incoming and outgoing network traffic and decides whether to allow or block specific traffic based on a defined set of security rules. Firewalls establish a barrier between secured and controlled internal networks that can be trusted and untrusted outside networks, such as the Internet. The firewall can be implemented at a node level, referred to as a “host firewall” which protects every individual device from malicious content in incoming or outgoing traffic. Alternately, the firewall can be implemented at a network level, referred to as a “network firewall” which monitors traffic between two disparate networks, such as between a local intranet and the Internet.

In the context of the specification, the term “processor” refers to one or more of a microprocessor, a microcontroller, a general-purpose processor, a Field Programmable Gate Array (FPGA), a Graphics Processing Unit (GPU), a Neural Processing Unit (NPU), a Tensor Processing Unit (TPU), an Application Specific Integrated Circuit (ASIC), and the like.

In the context of the specification, the phrase “memory unit” refers to volatile storage memory, such as Static Random Access Memory (SRAM) and Dynamic Random Access Memory (DRAM) of types such as Asynchronous DRAM, Synchronous DRAM, Double Data Rate SDRAM, Rambus DRAM, and Cache DRAM, etc.

In the context of the specification, the phrase “storage device” refers to a non-volatile storage memory such as EPROM, EEPROM, flash memory, or the like.

In the context of the specification, the phrase “communication interface” refers to a device or a module enabling direct connectivity via wires and connectors such as USB, HDMI, VGA, or wireless connectivity such as Bluetooth or Wi-Fi, or Local Area Network (LAN) or Wide Area Network (WAN) implemented through TCP/IP, IEEE 802.x, GSM, CDMA, LTE, or other equivalent protocols.

In the context of the specification, the phrase “communication network” refers to a group of several connected devices including computing devices (such as desktops, mobile handheld devices, tablet PCs, notebooks, etc.), local and remotely located servers (such as web servers, application servers, database servers, Application Program Interface (API) servers, load balancers, compute nodes, and the like), routers, antennas, modems, multiplexers, demultiplexers, and the like. In that regard, the aforementioned connected devices may be able to exchange data signals through wired and/or wireless means as per several combinations of several different communication protocols such as 802.11 (Wi-Fi), 802.3 (Ethernet), Bluetooth, NFC, ZigBee and 3GPP protocols such as HSPA, HSDPA, LTE, GSM, CDMA, WLL and the like.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings wherein like reference letters and numerals indicate the corresponding parts in various figures in the accompanying drawings, and in which:

FIG. 1 illustrates an example environment of devices in which several embodiments of the present invention may be implemented;

FIG. 2 illustrates an example multi-agent framework provided by a multi-agent framework server, in accordance with an embodiment of the present invention;

FIG. 3 illustrates a flow chart depicting a computer-implemented method for Artificial Intelligence (AI) based provision of market research, in accordance with an embodiment of the present invention;

FIG. 4 illustrates the assignment of a plurality of AI agents to a plurality of steps involved in automating market research, in accordance with an embodiment of the present invention;

FIG. 5A illustrates a pictorial representation of the AI-based automation of the market research, in accordance with an embodiment of the present invention;

FIG. 5B illustrates an exemplary app structure of the multi-agent framework, in accordance with an embodiment of the present disclosure.

FIGS. 6A and 6B illustrates an example market summary Graphic User Interface (GUI) of a computer-implemented application implementing several embodiments of the present invention;

FIG. 7 illustrates an example competitive analysis Graphic User Interface (GUI) of a computer-implemented application implementing several embodiments of the present invention;

FIG. 8 illustrates an example target demographics Graphic User Interface (GUI) of a computer-implemented application implementing several embodiments of the present invention;

FIG. 9 illustrates an example GUI depicting graph of customer trends as a part of a market research, by the computer-implemented application of FIG. 6;

FIG. 10 illustrates an example GUI depicting a market segmentation by customer generated by one or more AI agents of the computer-implemented application of FIG. 6;

In several embodiments of the invention, the AI agents are further customized by training them using fine-tuning techniques to enable them to be trained and implemented with minimal costs and lead times. The fine-tuning techniques include data-driven fine-tuning, prompt engineering, parameter optimization, and self-improvement techniques such as meta-learning, transfer learning, and agent self-analyses. The fine-tuning enables the AI agents to adapt to new tasks and environments and evaluate their performance to identify areas of improvement. Additionally, the system incorporates Reinforcement Learning from Human Feedback (RLHF), where the AI agents learn from user feedback to improve and personalize the results generated.

In several embodiments of the invention, the system includes a chart generator agent that extracts information from the data returned by the AI agents and selects from a series of chart templates to generate visualizations. The chart generator agent fills the data into the selected template or uses a code interpreter agent and the Matplotlib library to generate custom charts. Additionally, the system generates a series of recommended prompts based on the user's market research objective, selected competitors, and other prompts. The user can select these prompts to ask the system in a way that results in better results. Furthermore, the system recommends a series of follow-up questions to assist the user in conducting deeper research on a given subject, which the user can select to continue the search.

### DETAILED DESCRIPTION

Embodiments of the present invention disclosure will be described more fully hereinafter with reference to the accompanying drawings in which like numerals represent like elements throughout the figures, and in which example embodiments are shown. The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is therefore not to be taken in a limiting sense, and the scope of the present invention disclosure is defined by the appended claims. Embodiments of the claims may, however, be embodied in many different forms and should not be construed as limited to the embodiments set forth herein.

The terms “a” and “an” herein do not denote a limitation of quantity, but rather denote the presence of at least one of the referenced items. The terms “having”, “comprising”, “including”, and variations thereof signify the presence of a component.

Embodiments of the present invention disclose computer-implemented methods and computer systems for Artificial Intelligence (AI) based provision of management consulting. The present invention involves dividing the process of generation management consulting into several tasks. Each one of the several tasks is assigned one or more pre-trained Artificial Intelligence (AI) agents. The AI agents in that regard may be widely available pre-generated and trained AI agents offered by third parties or may be custom-generated AI agents generated by the processor implementing a unique code or may be combinations of several modules of the other third-party AI agents.

It is further envisaged that the AI agents have been further customized by training them using fine-tuning techniques to enable them to be trained and implemented with minimal costs and lead times. The implementation of the AI agents helps automate the workflows associated with each one of the several tasks. Furthermore, characteristic reference data, in addition to the training data, is provided to the AI agents. In that regard, the characteristic reference data may include real-world examples in the form of case studies, financial statements, contracts, marketing materials, demographics, and interview transcripts. The characteristic reference data may be sourced from several online resources (such as web pages, government data, proprietary market research data, public financial databases, etc.) through several data extraction techniques. The data extraction techniques may include the use of AI assistant retrieval agents, Retrieval-Augmented Generation (RAG) agents, web scraper agents, and visual web browsing agents. Moreover, for absorption of the characteristic reference data by the AI agents, the characteristic reference data may be provided as JavaScript Object Notation (JSON) objects and real-world examples.

The AI agents may further be provided interfaces in the form of APIs and data translation syntax so that they can exchange data received and generated amongst the AI agents. In that manner, an output of one AI agent may become an input for another AI agent, or two or more AI agents may act in a combined manner to generate desired deliverables. Wherever there may be a deficiency in the ability of an AI to handle one form of data or performance of one kind of task, that deficiency may be fulfilled by another AI or may be fulfilled by custom-generated code written using a compatible programming language such as Python. After all of the tasks of the management consulting have been completed, the data generated by the processor implementing the AI agents may be used by additional custom-generated code to generate documents in user-readable formats such as interactive and dynamic dashboards, spreadsheets, rich text format, etc. Moreover, translation and mapping functions may be defined to translate or convert the documents from one user-readable format (such as spreadsheet) to another user-readable format (such as rich text format).

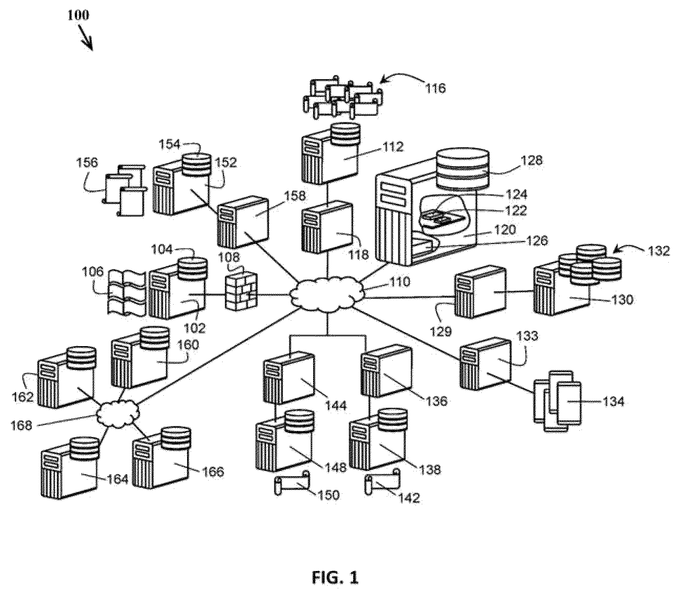

Several embodiments of the present invention will now be discussed in detail with reference to FIGS. 1-10.

FIG. 1 illustrates an example environment 100 of devices in which several embodiments of the present invention may be implemented. The environment 100 includes an Enterprise Data Management (EDM) server 102 configured to host an EDM application for the management of data concerning several organizations. Such data may include financial data such as investments, operational costs, company evaluation, payroll data, inventory stockpiles, accounting data such as purchases and sales, current liquidity, quarterly profits since the inception, values of shares, debentures, and other forms of bonds, etc. Some of the examples of EDM applications include Amazon Redshift, Ataccama ONE, Cloudera, Druva Phoenix, etc. The EDM server 102 is operably connected to an EDM storage device 104 that stores all the data in the form of EDM data files 106. The EDM server 102 is connected with a first communication network 110 through a firewall 108. The firewall 108 may be implemented as a network firewall, a host firewall, or combinations thereof.

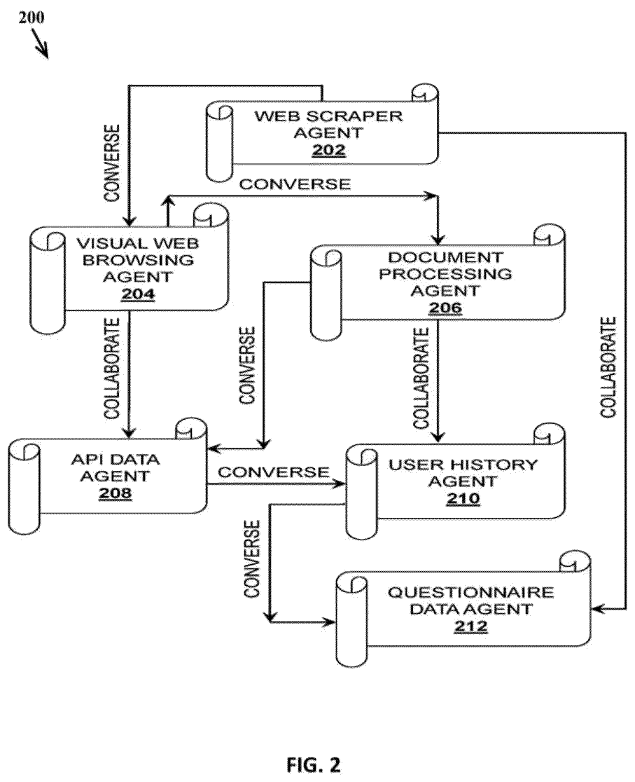

Further connected to the first communication network 110 is a multi-agent framework server 112. The multi-agent framework server 112 is configured to provide a multi-agent framework (See FIG. 2) by integrating several AI agents 116 collaborating to achieve rule-based tasks. In that regard, the framework may provide interfaces, languages, and protocols through which several AI agents may be able to communicate with each other. The AI agents offered by the multi-agent framework may be configured to be further customized for certain user-defined tasks through machine learning techniques such as fine-tuning.

The multi-agent framework server 112 is connected to the first communication network 110 through a framework API server 118. Furthermore, the multi-agent framework server 112 may allow integration of third-party AI agents 142 and 150 supported by several third-party AI servers 138 and 148 through their respective third-party AI agent API servers 136 and 144. Some of the examples of third-party AI agents 142 and 150 that may be integrated with the framework offered by the multi-agent framework server 112 include GoogleAI and OpenAI. It is to be noted that Google AI and OpenAI are examples of services that offer certain kinds of AI agents called LLM agents, however, the present invention is not limited to LLM agents alone and is envisaged to incorporate other kinds of AI agents such as domain-specific AI models, rule-based systems, expert systems, planning algorithms, reinforcement learning agents, human-in-the-loop systems, etc.

FIG. 2 illustrates an example multi-agent framework 200 (hereinafter referred to as “the framework 200”) provided by the multi-agent framework server 112, in accordance with an embodiment of the present invention. The framework 200 includes a web scraper agent 202, a visual web browsing agent 204, a document processing agent 206, an API data agent 208, a user history agent 210, and a questionnaire data agent 212. The web scraper agent 202 is configured to scrape through web pages provided by web servers concerning several different services such as social media, news organizations, blogs, company websites, and the like. Furthermore, the web scraper agent 202 is configured to extract data and useful insights from the scraped web pages. The visual web browsing agent 204 is configured to extract data and insights concerning visual data present in the web pages, such as images, videos, layouts, etc. In that regard, the visual web browsing agent 204 may be able to converse with the web scraper agent 202 to receive access to the web pages visited by the web scraper agent.

The document processing agent 206 is configured to extract data, information, and insights from several different forms of documents such as those available in the form of *.pdf files, *.docx files, *.xlsx files, *.png files, *.jpeg files, *.html files, *.xml files, etc. The documents processing agent 206 may also be able to converse with the visual web browsing agent 204 to receive insights extracted by the visual web browsing agent 204 and integrate those insights into the insights generated from document processing. The API data agent 208 is configured to receive data through API servers of services maintaining industry-specific information and research. Furthermore, the API data agent 208 is configured to extract valuable data and insights from the data received through the API servers. The API data agent 208 may also be configured to converse with the document processing agent 206 to leverage the document processing capabilities of the document processing agent 206 to extract insights from the API data.

The user history agent 210 is configured to collaborate with the document processing agent 206 and converse with the API data agent 208 to extract historical insights concerning the business for which market research would be provided. Therefore, the historical insights would be generated using the web pages analyzed by the web scraper agent 202 and the visual web browsing agent 204, and API data analyzed by the API data agent 208. Also, the questionnaire data agent 212 by obtaining historical insights from the user history agent 210 and collaborating with the web scraper agent 202 would generate a questionnaire for receiving valuable insights from the user(s). The questionnaire may be answered by a human user or an LLM agent acting as a simulated user.

Referring to FIG. 1, further connected to the first communication network 110 is a third-party data management server 152 through a third-party data management API server 158. The third-party data management server 152 may be configured to maintain additional organizational data 156 associated with several organizations in a third-party data management storage device 154. For example, the third-party data management server 152 may offer a service applicable to very specific aspects of business such as accounting and finance (for example, Google Analytics, Quickbook, Xero, Sage, etc.), employee payroll data, jurisdiction-wise product availability, and the like. Some of the rationales for moving at least some of the enterprise data to the third-party data management server 152 and the third-party management storage device 154 may include greater protection with higher levels of encryption, limited storage availability with the EDM storage device 104, regulatory requirements in a given jurisdiction, division of responsibilities in between personnel, outsourcing of certain services being more cost-effective compared to vertical integration, and the like.

Further connected to the first communication network 110 is a market research server 130 maintaining proprietary market research data in a plurality of market research storage devices 132. The market research server 130 is connected to the first communication network 110 through a market research API server 129. The market research data concerning a given industry or a product group may include surveys, interviews, outcomes of focus groups, experiments, observations, inferences, market reports (such as industry reports and analysis concerning market size, growth trends, competitor information, etc.), government data (such as information on demographics, economic trends, and consumer spending), media reports (such as articles, blogs, and social media conversations), and company reports (such as financial statements, annual reports, and press releases).

Furthermore, several web servers 160, 162, 164, and 166 hosting several websites and webpages concerning the industry of interest are connected to the first communication network 110 through a second communication network 168. For example, the websites may include social media websites, news publication websites, popular blogs, online marketplaces, online scientific journals, online journals maintained by regulatory bodies (such as the department of trade and commerce), etc. Additionally, a plurality of user computing devices 134 are also connected to the first communication network 110 through a user communication API server 133. The plurality of user computing devices 134 may include smartphones, Personal Digital Assistants (PDA), notebook PCs, tablet PCs, desktop PCs, and the like.

Furthermore, a central server 120 hosting an application representing the present invention is also connected to the first communication network 110. The central server 120 may be representative of a single device, a server stack, or a server farm including capabilities such as those of web servers, gateway servers, load balancers, compute nodes, application servers, database servers, and the like. In that regard, the central server 120 is envisaged to include a processor 122, a memory unit 124, a communication interface 126, and a storage device 128. The method steps of the present invention as will be discussed in the following discussion are envisaged to be performed by the processor 122 executing machine-readable instructions stored in the memory unit 124 and/or the storage device 128. The storage device 128 may store other information such as communication and data-exchange protocols for the exchange of data amongst two or more devices and/or two or more coded software modules, AI agents, LLM agents, and the like, IP addresses of the devices depicted in the environment 100, additional computing code in programming languages such as Python, several JSON libraries, and the like.

The storage device 128 may further be configured to store the data and the information collected, received, and/or generated by the processor 122 during the working of the present invention. The data stored in the storage device 128 may be stored in several database forms such as SQL databases and vector databases. It is to be noted here that the storage device 128 is representative of one or more storage devices located locally or remotely and accessible through corresponding database servers. Moreover, in several embodiments, for maintaining the security and integrity of the data stored in the storage device 128, the data may be stored in encrypted form and exchanged using security protocols such as Secure Service Layer (SSL) or Transport Layer Security (TLS) through public key infrastructure. Additional network firewalls and/or host firewalls may also be implemented for further security against hacking attacks.

Several embodiments of the present invention will now be elucidated using the environment 100 as a reference. However, a person skilled in the art would appreciate that the present invention as described in the following discussion may also be implemented in several alternate environments of computing devices without departing from the scope of the invention.

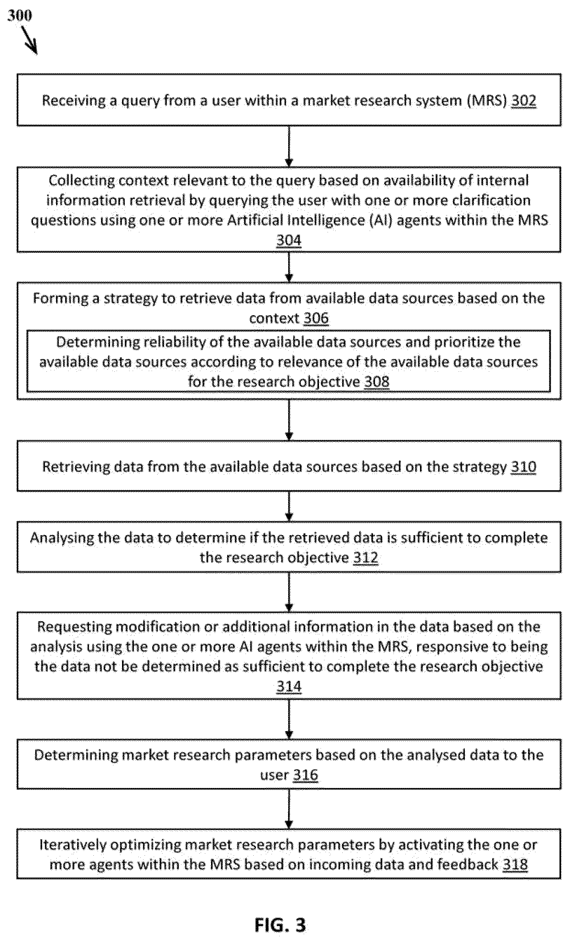

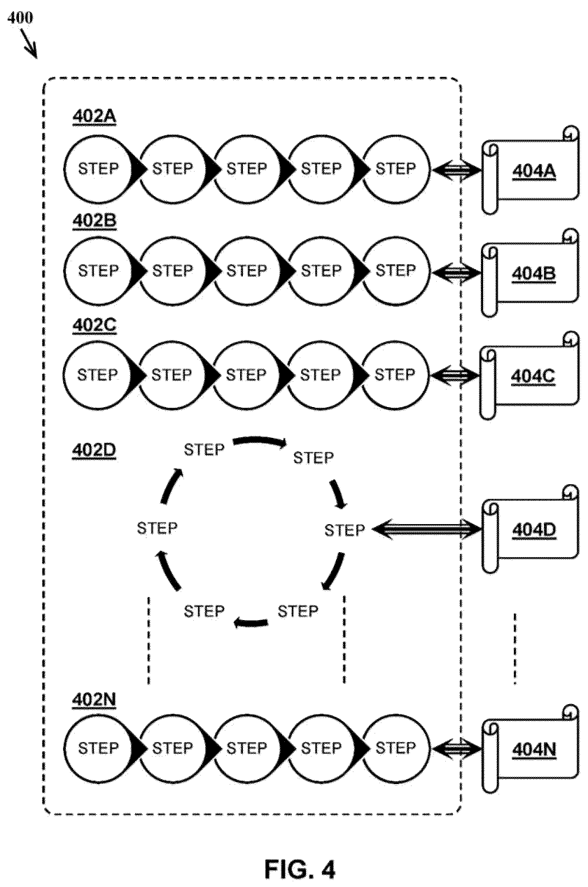

FIG. 3 illustrates a flow chart depicting a computer-implemented method 300 for automating market research using Artificial Intelligence (AI) agents, in accordance with an embodiment of the present invention. The computer-implemented method 300 includes a plurality of steps 400 (for example, 402A, 402B, 402C, 402D . . . 402N) for the automation of market research as illustrated in FIG. 4. The plurality of steps 402A, 402B, 402C, 402D . . . 402N are assigned to the plurality of AI agents 404A, 404B, 404C, 404D . . . 404N by the processor 122. It is to be noted here that each one of the plurality of tasks 402A, 402B, 402C, 402D . . . 402N is assigned at least one AI agent from the plurality of AI agents 404A, 404B, 404C, 404D . . . 404N. In general, whether accessing the AI agents 116 of the multi-agent framework 200 or the third-party AI agents 142 and 150, the AI agents have already been trained using generalized corpuses available through the Internet. However, it may be desirable that the plurality of AI agents 404A, 404B, 404C, 404D . . . 404N are further customized to suit industry-specific information for which the market research is being developed. In several embodiments of the invention, one or more of the plurality of AI agents 404A, 404B, 404C, 404D . . . 404N may further be customized by training the one or more of the plurality of AI agents 404A, 404B, 404C, 404D . . . 404N using fine-tuning techniques in conjunction with task-specific real-life examples and JSON data.

The fine-tuning of the AI agents enables them to adapt to new tasks and environments, and evaluate their performance to identify areas of improvement. The system also incorporates Reinforcement Learning from Human Feedback (RLHF), where the user-proxy agent 503 receives feedback from the user on the generated market research parameters. The feedback is then used by the processor 122 to refine and/or further modify the plurality of AI agents 404A, 404B, 404C, 404D . . . 404N, and the characteristic reference data. This iterative process allows the AI agents to learn from user feedback and improve the quality and relevance of the generated market research parameters over time.

Fine-tuning of the plurality of AI agents 404A, 404B, 404C, 404D . . . 404N can be performed in several manners. The fine-tuning can be data-driven where an AI agent is trained on a focused dataset relevant to a specific task that the AI agent has been assigned. Furthermore, data-driven fine-tuning can deploy any one or more of supervised learning, reinforcement learning, and imitation learning. Another form of fine-tuning is called prompt engineering, where prompts are adjusted specifically to receive tailor-made desired outputs from the AI agent. Prompt engineering is often used in conjunction with data-driven fine-tuning. Another form of fine-tuning includes parameter optimization. In parameter optimization, internal parameters of the corresponding neural network of an agent are directly adjusted based on feedback and performance metrics.

Self-improvement techniques may also be used for fine-tuning. Some examples of self-improvement techniques include meta-learning, where the AI agent learns how to learn allowing the AI agent to adapt to new tasks and environments, transfer learning, where knowledge and experience from previously learned tasks are applied to new tasks and environments, and agent self-analyses, where the AI agent evaluates its performance to identify areas of improvement. In addition to data-driven fine-tuning, prompt engineering, parameter optimization, and self-improvement techniques, there might be other fine-tuning techniques that may deployed to improve the efficiency and performance of the plurality of AI agents 404A, 404B, 404C, 404D . . . 404N. An example of fine-tuning is few-shot learning. Few-shot learning techniques offer several advantages such as quick adoption of new tasks, reduced data requirements, improved performance on small datasets, and increased AI capabilities.

At step 302, the processor 122 may receive a query from a user within a Market Research System (MRS). In an embodiment, the user may interact with a user-proxy agent 503 to initiate the query. In another embodiment, the processor 122 may receive a query from an agent. The agent may initiate the query when the user-proxy agent 503 may be requested by another agent to compile information to solve an objective.

In an embodiment the query may be a structured query or an unstructured query. The structured query may include standard report. The standard report may include, but is not limited to, Industry Report, Focus Group, Market Opportunity Assessment, Competitive Benchmark Analysis, etc. The unstructured query may include a research objective and one or more questions from the user. Examples of questions may include, but is not limited to, “what are the best cities for me to expand our line of snacks foods in Canada?”, “how many used cars were sold in Singapore in 2012?.”

At step 304, the processor 122 may collect context relevant to the query based on availability of internal information retrieval by querying the user with one or more clarification questions using one or more Artificial Intelligence (AI) agents from the plurality of AI agents 404A, 404B, 404C, 404D . . . 404N. In an embodiment, the internal information may include simulating user personas and gather insights into user preferences and behaviours. In an embodiment, the one or more clarification questions may be provided to gather additional details to refine the research, and if the internal information retrieval is not available, the clarification questions are provided to establish a baseline of the context. In an embodiment, the context relevant to the query may include the information about the user including target demographics, company goals, pricing strategies, and product features. For example, identifying optimal cities for a company's snack food line expansion in Canada hinges on understanding factors like target demographics, product features, pricing, corporate objectives, and other relevant elements.

In an embodiment, the processor 122 may collect the context relevant to the query based on internal information retrieval. Internal information retrieval may be facilitated through the plurality of AI agents 404A, 404B, 404C, 404D . . . 404N, enabling retrieval of company-related data from uploaded documents, user activity logs, and connected APIs. The user-proxy agent 503, acting as a mediator, initiates this retrieval process by comprehending the context, shaping its methodology, and posing relevant clarifying questions. Each retrieval agent within the system possesses distinct ownership over specific types of company information, providing tailored responses to inquiries directed by the user-proxy agent 503.

In another embodiment, the processor 122 may collect the context relevant to the query based on the clarifying question. The clarifying questions serve to enhance the understanding of the query by providing additional context, particularly when internal information retrieval is accessible. The user-proxy agent 503 integrates these clarifying questions into a comprehensive questionnaire, which the user completes via an online form or through conversational interactions facilitated by the ChatGPT Wisper API. Examples of clarifying questions include inquiries about the target demographics of the snack foods, aimed at eliciting specific details to refine the research objective. In cases where internal information retrieval is utilized, follow-up questions may be prompted based on previously collected data. For instance, the system may inquire about the focus of the user's snack food product lines to tailor the research approach accordingly.

At step 306, the processor 122 may form a strategy to retrieve data from available data sources based on the context relevant to the query. At step 308, the processor 122 may determine reliability of the available data sources and prioritize the available data sources according to relevance of the available data sources for the research objective. The available data sources may include non-agent sources such as web scraping, Application Programming Interface (API) endpoints, web browsing, and uploaded files, as well as agent-based sources such as synthetic focus groups, synthetic surveys, and autonomous survey collection. The strategy formation may further include adjusting the strategy formation based on feedback received from the user.

In an embodiment, the web scraping may include entails gathering information exclusively from first-party sources, such as competitor websites, social media profiles, competitor press releases, or approved news websites and trade publications. In an embodiment, the API endpoints may include data may source from paid or free APIs, including subscription-based services like web analytics (e.g., Similarweb, SEMrush), government data (e.g., FRED, US Census), and stock market data (e.g., AlphaVantage). In an embodiment, the web browsing may include utilized for extracting data from non-structured or complex sources, such as the US Census library or Pew Research, where APIs are unavailable or challenging to navigate. Visual web browsing agents facilitate website navigation and utilize native search functionality to access desired information. In an embodiment, the uploaded files may include users submit files containing proprietary data, custom reports, surveys, or other relevant information. These files are ingested and stored in a vector database for further analysis within the MRS.

In an embodiment, the synthetic focus group may include a tool within the Market Research System (MRS) designed to aid users in product planning, pricing, and marketing targeting. It operates as an independent model from the MRS, utilizing large language models (LLMs) such as GPT to simulate user personas accurately. The user may interact with the MRS by user-proxy agent 503 through dynamic questioning to gather objectives and company information. It generates median user personas representing different cohorts, each with demographic details and a set of 10-15 questions to complete the research objective. Responses from these focus groups are synthesized into a report by a separate agent, providing key findings for user review. Cohort agents remain accessible for further questioning, allowing ongoing engagement for additional insights.

In an embodiment, the synthetic survey may include a single persona cohort and generate multiple variations (N), determined by the user proxy agent to achieve adequate diversity. Each cohort variation expands parameters beyond the median, encompassing sub-segments with varying income levels, hobbies, and demographics. Questions mirror those of a synthetic survey, incorporating multi-choice and single-choice formats. Responses from each agent are aggregated to provide comprehensive insights to the human user or Market Research System (MRS). Notably, the MRS boasts a larger sample size and the ability to discern nuances in how sub-segments of the cohort may respond, enhancing the depth and accuracy of market research analysis.

In an embodiment, the autonomous survey collection may include insight for specialized audiences not within GPT's training data. The Autonomous Survey Collection (ASC) employs third-party tools like SurveyMonkey or first-party tools like LinkedIn and email, especially for easily filterable companies. Third-party tools involve a visual web browsing agent to order surveys, process responses via email, and deliver questionnaires until sufficient data is collected. For first-party data, ASC uses LinkedIn profiles or lead generation software like Zoom info to find audience parameters, sending InMail messages or emails with industry surveys and custom forms. Users verify responses via ProAI landing pages, inputting company emails to prevent fraud. The process repeats until enough responses are obtained, ensuring data reliability and quality for B2B research. After collecting data from the dynamic forms, the responses will be either presented directly to the user if the system is employed as a standalone research report or fed back into the MRS if it's utilized to fulfill the objective.

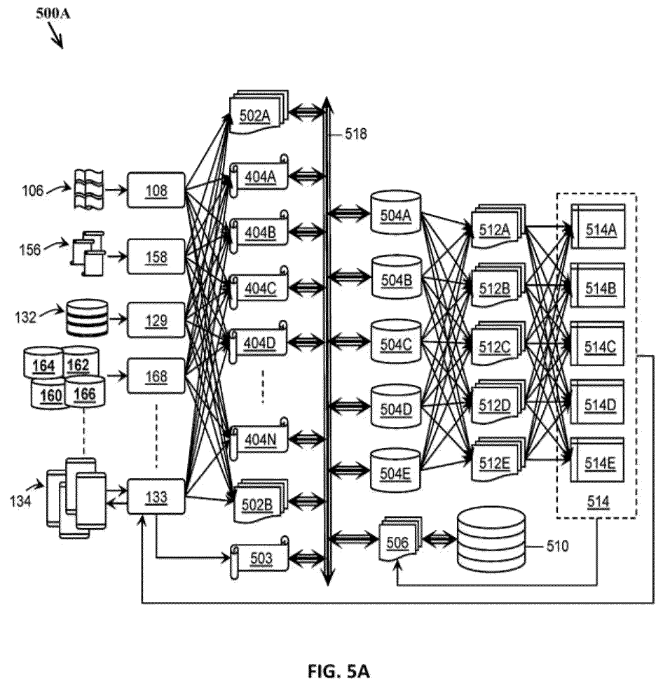

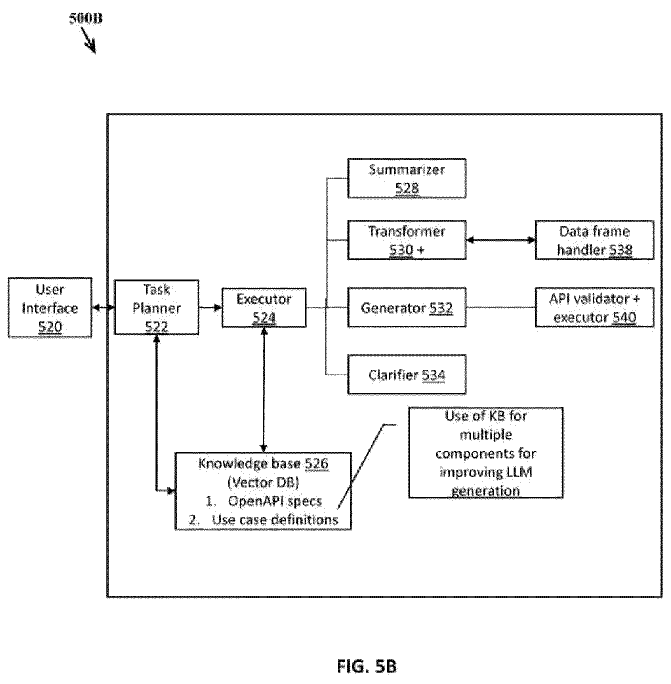

FIG. 5A illustrates a pictorial representation of the automating market research using artificial intelligence, in accordance with an embodiment of the present invention. The goods and/or services data may be obtained in the form of EDM data files 106 derived from the EDM storage device 104 through the EDM server 102 and the firewall 108. The EDM data files 106 may be available in several different formats such as *.docx, *.xlsx, *.pdf, *.png, *.jpeg, and other proprietary file formats. Furthermore, additional organizational data 156 may be obtained from third-party data management storage device 154 through the third-party data management server 152 and the third-party data management API server 158. Here again, the additional organizational data 156 may be available in several different formats such as *.docx, *.xlsx, *.pdf, *.png, *.jpeg, and other proprietary file formats.

The scraped data may be obtained by the web scraper agents visiting several websites including the websites of users accessing the services claimed through the present invention, competitor websites, websites of regulatory bodies, periodic industrial surveys published online by private and public agencies, popular online magazines publications, newsletters, journals, and blog posts concerning the industry to which the user belongs. Such websites and webpages may be made available by web servers 160, 162, 164, and 166 and may be accessible to the processor 122 through the first communication network 110 and the second communication network 168. Here again, the code segments 502A and 502B may enable the plurality of AI agents 404A, 404B, 404C, 404D . . . 404N to obtain useful information from the websites and the webpages.

In an embodiment, the processor 122 may collect the context relevant to the query based on internal information retrieval. Internal information retrieval may be facilitated through the plurality of AI agents 404A, 404B, 404C, 404D . . . 404N, enabling retrieval of company-related data from uploaded documents, user activity logs, and connected APIs. The user-proxy agent 503, acting as a mediator, initiates this retrieval process by comprehending the context, shaping its methodology, and posing relevant clarifying questions. Each retrieval agent within the system possesses distinct ownership over specific types of company information, providing tailored responses to inquiries directed by the user-proxy agent 503.

In another embodiment, the processor 122 may collect the context relevant to the query based on the clarifying question. The clarifying questions serve to enhance the understanding of the query by providing additional context, particularly when internal information retrieval is accessible. The user-proxy agent 503 integrates these clarifying questions into a comprehensive questionnaire, which the user completes via an online form or through conversational interactions facilitated by the ChatGPT Wisper API. Examples of clarifying questions include inquiries about the target demographics of the snack foods, aimed at eliciting specific details to refine the research objective. In cases where internal information retrieval is utilized, follow-up questions may be prompted based on previously collected data. For instance, the system may inquire about the focus of the user's snack food product lines to tailor the research approach accordingly.

In that regard, the processor 122 may perform post-processing such as Optical Character Recognition (OCR), image processing, parsing, etc. to convert the obtained EDM data files 106 and the additional organizational data 156 into JSON objects. The JSON objects may then be absorbed by the plurality of AI agents 404A, 404B, 404C, 404D . . . 404N. The conversion of EDM data files 106 and the additional organizational data 156 into JSON objects may be added to the plurality of AI agents 404A, 404B, 404C, 404D . . . 404N through custom-generated features coded in a compatible programming language such as Python. The custom-generated features are represented by code segments 502A and 502B in FIG. 5A.

The short-term memory data such as sales figures, inventory levels, customer feedback, and short-term market trends, and the long-term memory data such as historical performance data, customer demographics, and behavior, and to some extent, competitive landscape and industry trends may also be extracted by the processor 122 from the EDM data files 106 and the additional organizational data 156. In another context, short-term memory may be attributed to in-context memory and knowledge passed in JSON stored temporarily to assist in a long-sequence chain of thought reasoning (for example, “what should I have for dinner today?” “I had Cheese yesterday, but don't remember what I had a week ago”). However, long-term memory is context retrieved via the RAG agent (E.g. “I am on a diet and have been for the past eight months”).

In an example context of the present invention, the framework followed by the RAG agent may include six (6) steps including:

Splitting and Chunking: Each page of a document is split in a predefined precedence (for example, ‘\n\n’, ‘\n’, ‘ ’, ″) and the size of each split (also referred to as a chunk) is about three-hundred and fifty (350) characters with a hundred and thirty-five (135) character overlap. The reason for a smaller chunk size is that a more granular search can be performed which helps identify information that is not readily accessible.

Saving vectors: Vectors are then saved in a vector database, by adding an index (like page number, that will be useful in the later stages) to each one of the vectorized chunks.

Query enhancement: Once the vectors are saved in the vector database, a user query is accessed, and multiple different versions (for example, three (3) to five (5) versions) of the accessed user query are generated. The multiple different versions may be attributed to multiple different manners in which the same user query can be rephrased without changing the substantive meaning of the query.

Retrieval: A predefined number of chunks (for example, top three (3) chunks) are retrieved for all the different versions of the accessed user query.

Extending the chunks: One (1) to two (2) chunks ahead and prior for all the top chunks are also fetched in addition to the predefined number of chunks. All of the retrieved and/or fetched chunks are utilized during the generation of the answers. The rationale for fetching additional chunks lies in the fact that sometimes during the similarity search on the vector chunks, similar content is present at the top or the bottom of the page, which might have continuation or prior information on that topic respectively, and those texts might get missed if only the originally retrieved top chunks are used for generating the answers.

Generating Answers: All of the retrieved and/or fetched chunks are then sent to an AI agent responsible for generating the answers.

The short-term and long-term memory data may then be parsed and converted into JSON objects by the processor 122 for absorption by the plurality of AI agents 404A, 404B, 404C, 404D . . . 404N. Other sources of short-term and long-term memory data may include Automated Information Management Services such as Enterprise Content Management (ECM), Document Management Systems (DMS), Business Intelligence (BI) and analytics platform, Customer Relationship Management (CRM) systems, Enterprise Resource Planning (ERP) systems, and Electronic Content Management (ECM) systems all of which may be available through EDM data files 106 and the additional organizational data 156.

In several embodiments of the invention, the processor 122 may further provide an upload link to the user to upload documents in several different formats such as *.docx, *.xlsx, *.pdf, *.png, *.jpeg to the storage device 128, using the plurality of user computing devices 134 and through the user communication API server 133. In several alternate embodiments, one of the plurality of AI agents 404A, 404B, 404C, 404D . . . 404N may generate a questionnaire or a survey based on information received from the EDM data files 106 and the additional organizational data 156 and present the questionnaire or the survey to the user at the plurality of user computing devices 134. The user may then respond to the questionnaire or the survey, which may then be converted into JSON objects by the processor 122. The JSON objects thus generated may then be fed to one or more of the plurality of AI agents 404A, 404B, 404C, 404D . . . 404N.

The scraped data may be obtained by the web scraper agents visiting several websites including the websites of users accessing the services claimed through the present invention, competitor websites, websites of regulatory bodies, periodic industrial surveys published online by private and public agencies, popular online magazines publications, newsletters, journals, and blog posts concerning the industry to which the user belongs. Such websites and webpages may be made available by web servers 160, 162, 164, and 166 and may be accessible to the processor 122 through the first communication network 110 and the second communication network 168. Here again, the code segments 502A and 502B may enable the plurality of AI agents 404A, 404B, 404C, 404D . . . 404N to obtain useful information from the websites and the webpages.

In several scenarios, pre-existing LLM agents may be used as some of the plurality of AI agents 404A, 404B, 404C, 404D . . . 404N. The LLM agents have conventionally been trained on large amounts of text data, therefore they are not as good at understanding numerical relationships and operations as they are in the context of text-based information. Although LLM agents with increased dexterity in manipulating numerical data are always emerging they still have a long way to go before they can be accepted as reliable business tools for handling numerical data. Such shortfall may be addressed by the code segments 502A and 502B, in a manner that the code segments 502A and 502B, when executed by the processor 122, add custom-generated features to the plurality of AI agents 404A, 404B, 404C, 404D . . . 404N enabling the present invention to handle and manipulate numerical relationships and operations.

Referring to FIG. 3, at Step 310, the processor 122 may retrieve data from the available data sources based on the strategy. Further at step 312, the processor 122 may analyze the data to determine if the retrieved data is sufficient to complete the research objective using the user-proxy agent 503. In an embodiment, after completing the Data Collections and Retrieval step, the information is relayed back to the user-proxy agent 503. The user-proxy agent 503 then consults the formed strategy to assess whether the gathered information is sufficient to achieve the research objective. If deemed insufficient, at step 314, the processor 122 may request modification or additional information in the data based on the analysis using the one or more AI agents within the MRS, responsive to the data not being determined as sufficient to complete the research objective. The user-proxy agent 503 requests modifications from alternative retrieval agents, with the selection facilitated by the group chat manager. This iterative process continues until the user-proxy agent 503 reaches a satisfactory level of confidence in achieving the objective, as determined by either a human user or a moderator agent that reviews the methodology and objective, providing feedback.

For objectives tied to the company's context (e.g., identifying geographic markets for expansion), the user-proxy agent 503 may engage the Retrieval Augmented Generation (RAG) agent. Contextual information about the company, including long-term and short-term goals, along with company size, location, products/services, target market, and pricing, is considered. This contextual data aids in providing tailored suggestions to the human user, whether in dynamic or structured reports, user interactions, or for future use in Business Strategy modules.

At step 316, the processor 122 may determine the market research parameters based on the analysed data to the user. In an embodiment, the market research parameters may include dynamic reports with visualizations and/or structured reports based on predefined templates. In an embodiment, the structured reports provided to the user are generated based on predefined templates utilizing the one or more AI agents within the MRS to fill in relevant data and analysis.

Further, the processor 122 may display the market research parameters including the dynamic reports with the visualizations including the charts, the graphs, and the tables to convey the analysed data.

In an embodiment, the dynamic reports may include charts, graphs, and tables generated from a library of visual assets using a JS Chart library. The Objective Completion layer compiles findings and raw data into a single output, processed into a visual interface. A dashboard configuration agent maps data to appropriate charts or tables (e.g., pie chart, line chart), presenting the response, reasoning, and supporting data to the user. Additionally, a CoPilot agent is available for further inquiries, accessing user queries, supporting data, and prior agents used for information retrieval, ensuring contextually relevant responses.

In an embodiment, the structured reports may follow a standardized format, providing guardrails for complex tasks where many Language Models (LLMs) may struggle with reasoning and optimal methods. These reports concentrate computational resources on individual sections, enhancing the quality of each step. By enforcing downstream methodologies through few-shot learning or fine-tuning, consistency and structure may maintain, minimizing errors and hallucinations. This approach increases reliability and ensures that LLMs follow predefined guidelines, enhancing the overall quality and coherence of the structured reports.

At step 318, the processor 122 may iteratively optimize market research parameters by activating the one or more agents within the MRS based on incoming data and feedback. Further, the optimization of the market research parameters may include iteratively finetuning the one or more AI agents within the MRS based on the data, user feedback, and predefined optimization criteria.

In an embodiment, a plurality of interfaces to the plurality of AI agents 404A, 404B, 404C, 404D . . . 404N for enabling exchanges of data amongst the plurality of AI agents 404A, 404B, 404C, 404D . . . 404N. The plurality of interfaces is represented by a common communication bus 518 in FIG. 5. In that regard, anyone AI agent of the plurality of AI agents 404A, 404B, 404C, 404D . . . 404N can communicate with any other AI agents of the plurality of AI agents 404A, 404B, 404C, 404D . . . 404N using one or more of the plurality of interfaces, such as through the common communication bus 518. It is to be noted here that in several embodiments of the invention, the common communication bus 518 may be replaced with several independent communication buses each allowing the exchange of data and information between two or more AI agents and/or coded segments through distinct protocols. In that regard, the specific architecture of the implementation of the plurality of interfaces may differ from one application paradigm of the present invention to another application paradigm. For example, the plurality of interfaces may utilize Application Programming Interfaces (APIs), data translation protocols, messaging formats, and object models to enable communication between the plurality of AI agents 404A, 404B, 404C, 404D . . . 404N.

Furthermore, the processor 122 may define inter-agent communication protocols for efficient communication amongst the plurality of AI agents 404A, 404B, 404C, 404D . . . 404N. The provision of the plurality of interfaces allows services offered through the present invention to be modular in architecture. A module may be defined using one or more AI agents for achieving a set of functional objectives. Therefore, different modules may be combined in several different manners to customize the present invention for different industry types, industry sizes, and business objectives. The user(s) may communicate with the plurality of AI agents 404A, 404B, 404C, 404D . . . 404N using one or more of the user computing devices 134. The receipt of user inputs may be facilitated by the processor 122 executing a user-proxy agent 503. For example, during the generation of the marketing plan as discussed in the preceding discussion, the formulated strategic goals may be presented as several ‘Tables of Contents’ to the user. The user may (5) select one specific table of contents or choose segments from the distinct tables of contents to generate a customized table of contents. Steps (6) to (10) may then be carried out in conformity with user selected or generated table of contents.

In several embodiments of the invention, the user-proxy agent 503 may act as a voice-interview agent that collects information from a human user and utilizes a voice-to-text API to enable voice communication with a user using several mediums such as through GSM, VoIP, VoLTE, or VoWiFi, etc. to collect the desired information. Answers to the questions asked by the interview agent are then processed by the processor 122 before being entered into the JSON library containing several fields of information about the business or the company for which the management consulting is being provided. In either of the scenarios, where the user is being asked questions in the text-form or the voice-form by the user-proxy agent 503, the user-proxy agent 503 may further be configured to generate a dynamic questionnaire based on gaps left after all other sources of information such as Self-Querying Doc Uploads, Voice Transcriptions, or inputs our outputs of prior plans generated have been analyzed. In that regard, additional fields labeled as “Clarifying Questions” may be generated and populated dynamically based on the information needed for the specific report section, company stage, industry, etc. The received user inputs required at one or more stages of provision of management consulting may then be provided to the plurality of AI agents 404A, 404B, 404C, 404D . . . 404N by the processor 122.

The processor 122 implementing the plurality of AI agents 404A, 404B, 404C, 404D . . . 404N may be able to generate a large amount of data concerning the intended goals of the present invention. The data generated by the processor 122 implementing the plurality of AI agents 404A, 404B, 404C, 404D . . . 404N may pertain to financial forecasting, dynamically generated and modifiable business plans, market research plans, operating plans, and expansion plans. For example, the RAG agent may use the vector databases of storage device 128 to generate data which may later be used by an AI agent acting as a simulated user for generating marketing plans or expansion plans. The AI agent acting as the simulated user may also have access to the SQL databases and all other forms of data, using which the AI agent may formulate a strategy for the provision of management consulting. Such information may be stored in information repositories 504A, 504B, 504C, 504D, and 504E as shown in FIG. 5A.

Referring to FIG. 5B illustrates an exemplary architecture 500B of the multi-agent framework, in accordance with an embodiment of the present disclosure. The architecture 500B is explained in conjunction with FIG. 5A.

The architecture 500B may include a user interface 520, a task planner 522, an executor 524, a knowledge base 526, a summarizer 528, a transformer 530, a generator 532, a clarifier 534, a data frame handler 538, an API validator and executor 540.

The task planner 522 generates a comprehensive plan in response to user queries. In an embodiment, the task planner 522 utilizes few-shot prompts and training examples to formulate a step-by-step plan tailored to the user's requirements. The plan encompasses various actions, including API calls, data transformation, and summarization.

The executor 524 executes the plan generated by the task planner 522. The executor 524 sequentially implements the steps outlined in the plan. It coordinates with specialized agents, such as the generator 532, the transformer 530, and summarizer 528, to carry out specific tasks efficiently. The generator 532 generates validated API calls based on the plan. The generator 532 creates API requests according to the instructions provided in the plan. It ensures the validity and accuracy of the generated calls before execution. The transformer 530 transforms API response data according to plan specifications. The Transformer 530 receives API responses and applies predefined transformations specified in the plan. These transformations may include data formatting, filtering, or aggregation to meet the desired output criteria. The summarizer 528 generates concise summaries of transformed data. The summarizer 528 synthesizes the transformed data into concise summaries, adhering to the instructions outlined in the plan. These summaries provide users with actionable insights and relevant information. Integration with the Knowledge Base (Vector DB) 526 such as Knowledge Base Content, OpenAPI Specs, Use Case Definitions, Correct/Incorrect Answers, Conversation History, Utilization in LLM Generation:

The knowledge base 526 enriches the Language Model's (LLM) generation process by providing relevant context derived from stored information such as OpenAPI specifications, historical conversation data, and validated use case definitions.

The architecture 500B also includes a chart generator agent that extracts information from the data returned by the AI agents and selects from a series of chart templates to generate visualizations. The chart generator agent fills the data into the selected template or uses a code interpreter agent and the Matplotlib library to generate custom charts. This enables the system to present the market research findings in a visually compelling and easily understandable format.

Moreover, the architecture 500B generates a series of recommended prompts based on the user's market research objective, selected competitors, and other prompts. The user can select these prompts to ask the system in a way that results in better results. This feature helps guide the user in asking the right questions to obtain the most relevant and accurate market research information.

Additionally, the architecture 500B recommends a series of follow-up questions to assist the user in conducting deeper research on a given subject. The user can select these follow-up questions, and the system will continue the search based on the selected question. This iterative process enables the user to delve deeper into specific aspects of the market research and obtain more detailed insights.

Referring to FIG. 3 and FIG. 5A, the processor 122 may then execute deliverable-generating code segments 512A, 512B, 512C, 512D, and 512E to generate a plurality of deliverables 514A, 514B, 514C, 514D, and 514E using the data stored in the information repositories 504A, 504B, 504C, 504D, and 504E. The deliverable-generating code segments 512A, 512B, 512C, 512D, and 512E may include machine-readable instructions for implemented Google Workspace Templates, Gantt Chart generators, and Key Performance Indicator (KPI) generators. The plurality of deliverables 514A, 514B, 514C, 514D, and 514E may be generated in user-readable formats such as a dashboard interface, spreadsheets, and rich text format. For example, the plurality of deliverables 514A, 514B, 514C, 514D, and 514E may include Google Workspace Documents created using Google Workspace Templates, Gantt Charts generated by Gantt Chart generators, and KPIs generated by KPI generators.

Moreover, the plurality of deliverables 514A, 514B, 514C, 514D, and 514E together constitute market research 520. In several embodiments of the invention, the deliverable-generating code segments 512A, 512B, 512C, 512D, and 512E may further provide mapping functions enabling the processor 122 to translate data from one user-readable format to another user-readable format, of the plurality of user-readable formats.

In several embodiments of the invention, the processor 122 may then validate the plurality of deliverables 514A, 514B, 514C, 514D, and 514E by executing a validation code segment 506 using industry benchmark data stored in an industry benchmark data database 510, as a reference. In that regard, for validating the plurality of deliverables 514A, 514B, 514C, 514D, and 514E, the processor 122 may utilize metrics including Key Performance Indicators (KPIs), benchmarking, regression analysis, gap analysis, and requirements traceability matrices. The industry benchmark data database 510 may be maintained in the storage device 128. Furthermore, the processor 122 may further receive user feedback on the plurality of deliverables 514A, 514B, 514C, 514D, and 514E through surveys, query responses, and explicit ratings. In case, the plurality of deliverables 514A, 514B, 514C, 514D, and 514E do not conform with the industry benchmark data, the processor 122 may then modify one or more of the plurality of tasks, the plurality of AI agents 404A, 404B, 404C, 404D . . . 404N, and the characteristic reference data provided to the plurality of AI agents 404A, 404B, 404C, 404D . . . 404N, following the failure of the validation of the plurality of deliverables 514A, 514B, 514C, 514D, and 514E. Steps 302-310 may be repeated until certain predefined performance thresholds, such as, convergence with industry benchmark data are achieved.

After the convergence is validated by the processor 122, the plurality of deliverables 514A, 514B, 514C, 514D, and 514E may be provided to the user(s) at the plurality of user computing devices 134, and through the user communication API server 133. In several embodiments, the user(s) may be able to provide feedback using user interfaces provided at the user computing device 134. The user-proxy agent 503 on execution may then allow the processor 122 to receive the feedback through the user communication API server 133 and refine and/or further modify the plurality of AI agents 404A, 404B, 404C, 404D . . . 404N, and the characteristic reference data in response to receipt of the feedback.

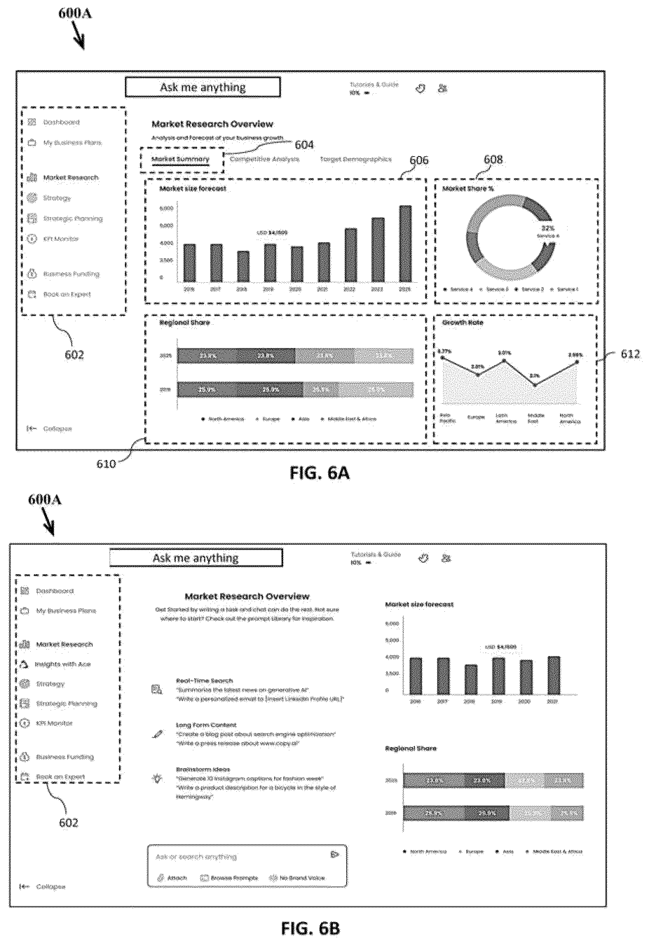

FIGS. 6A and 6B illustrates an example market summary Graphic User Interface (GUI) 600A of a computer-implemented application implementing several embodiments of the present invention. The market summary GUI 600A illustrates a list of services or deliverables 602 offered by the computer-implemented application (hereinafter also referred to as “the solution”). For example, the list of deliverables 602 may include business planning, market research, strategic planning, Key Performance Indicators (KPI) monitoring, etc. The market summary GUI 600A also illustrates a market summary 604, a market size forecast 606, a market share 608, a regional rate 610, a growth rate 612, etc. of a business entity accessing the service offered by the solution. The market summary 604 may be provided by a human operator or an AI agent of the plurality of AI agents 404A, 404B, 404C, 404D . . . 404N, acting as a simulated user and using all the additional references available to the AI agent from the plurality of data sources.

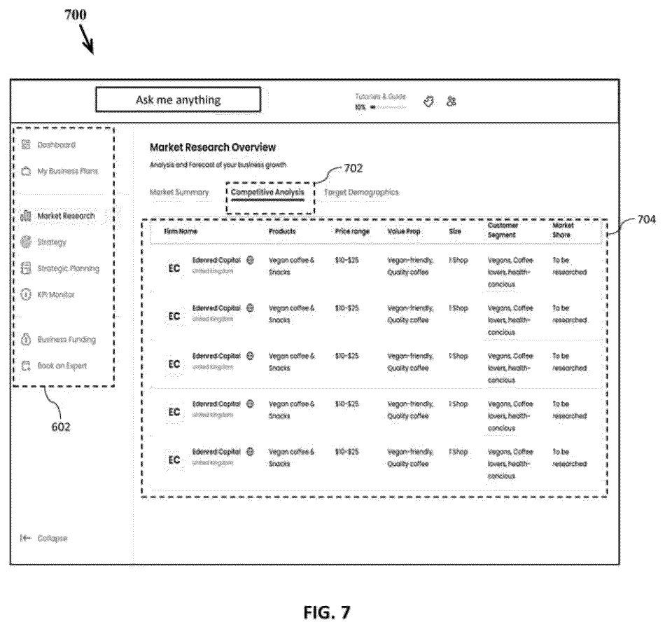

FIG. 7 illustrates an example competitive analysis Graphic User Interface (GUI) 700 of a computer-implemented application implementing several embodiments of the present invention. The competitive analysis GUI 700 illustrates a list of services or deliverables 602 offered by the computer-implemented application (hereinafter also referred to as “the solution”). For example, the list of deliverables 602 may include business planning, market research, strategic planning, Key Performance Indicators (KPI) monitoring, etc. The competitive analysis GUI 700 also illustrates a competitive analysis 702, and a competitive analysis chart 704. Further, the competitive analysis chart 704, may include a firm name, a product, a price range, a value prop, a size, a customer segment, and a market share, etc. of a business entity accessing the service offered by the solution. The competitive analysis 702 may be provided by a human operator or an AI agent of the plurality of AI agents 404A, 404B, 404C, 404D . . . 404N, acting as a simulated user and using all the additional references available to the AI agent from the plurality of data sources.

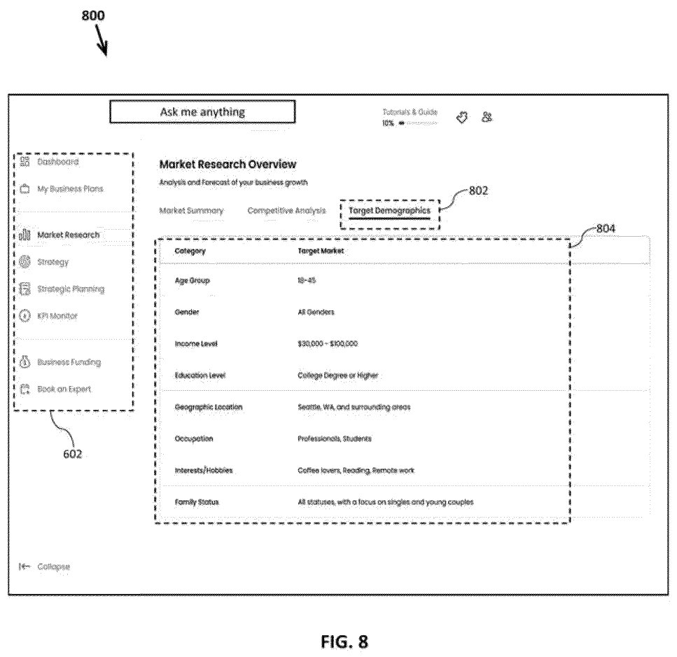

FIG. 8 illustrates an example target demographics Graphic User Interface (GUI) 800 of a computer-implemented application implementing several embodiments of the present invention. The target demographics GUI 800 illustrates a list of services or deliverables 602 offered by the computer-implemented application (hereinafter also referred to as “the solution”). For example, the list of deliverables 602 may include business planning, market research, strategic planning, Key Performance Indicators (KPI) monitoring, etc. The target demographics GUI 800 also illustrates a target demographics 802, and a target demographics chart 804. Further, the target demographics chart 804 may include a category, and a target market, etc. of a business entity accessing the service offered by the solution. The target demographics 802 may be provided by a human operator or an AI agent of the plurality of AI agents 404A, 404B, 404C, 404D . . . 404N, acting as a simulated user and using all the additional references available to the AI agent from the plurality of data sources.

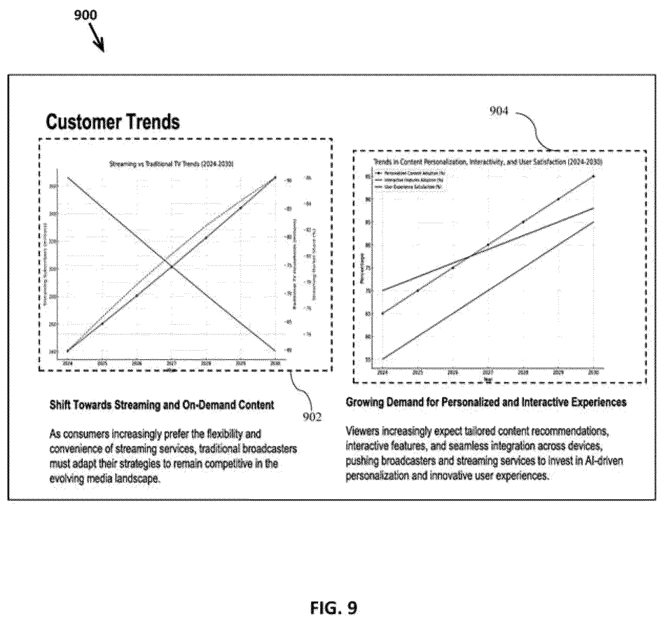

FIG. 9 illustrates an example GUI 900 depicting graph of customer trends as a part of a market research, by the computer-implemented application of FIG. 6. The graph may include a shift towards streaming and On-demand content 902, and a growing demand for personalized and interactive experiences 904. The shift towards streaming and On-demand content 902 may depict the graph between a streaming vs traditional TV trend. The streaming vs traditional TV trend may show a consumer increasingly prefer the flexibility and convenience of streaming services, and traditional broadcasters adapt their strategies to remain competitive in the evolving media landscape. The growing demand for personalized and interactive experiences 904 may depict the graph between a trend in content personalization, an interactivity, and a user satisfaction.

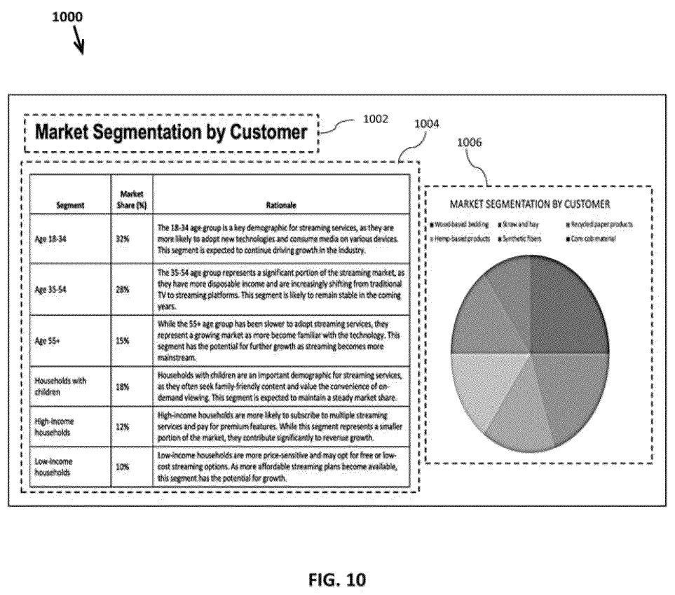

FIG. 10 illustrates an example GUI 1000 depicting a market segmentation by customer 1002 generated by one or more AI agents of the computer-implemented application of FIG. 6. The market segmentation by customer 1002 may include a market segmentation by customer in detail chart 1004, and a market segmentation by customer in pie chart 1006. The market segmentation by customer in detail chart 1004 may include a segment, a market share, and a rationale. The market segmentation by customer in detail chart 1004 may include a visual representation in the form of the pie chart 1006.

The present invention, as described through the embodiments discussed above offers several advantages. For example, the entire process of market research can be fully automated and scaled up or down to meet the demands of several kinds of businesses with several different sizes in terms of revenues or personnel. The AI agents can be combined in multiple ways to generate modules that may further be combined in several different manners to generate a large and varied set of market research solutions. The solution can be fully automated and therefore requires minimal human intervention allowing the solution to be provided at relatively lower costs allowing even small businesses to have access to quality data-based market research services. Since the solution leverages a lot of historical data and systems already associated with the concerned business, the deliverables offered are highly customized and can be seamlessly integrated into existing processes. The customized solutions also greatly diminish the inertia that is generally experienced in businesses undergoing radical changes to their current processes.

Various modifications to these embodiments are apparent to those skilled in the art, from the description and the accompanying drawings. The principles associated with the various embodiments described herein may be applied to other embodiments. Therefore, the description is not intended to be limited to the embodiments shown along with the accompanying drawings but is to provide the broadest scope consistent with the principles and the novel and inventive features disclosed or suggested herein. Accordingly, the invention is anticipated to hold on to all other such alternatives, modifications, and variations that fall within the scope of the present invention and appended claims.

1. A computer-implemented method for automating market research, the computer-implemented method comprising:
receiving a query from a user within a Market Research System (MRS), wherein the query comprises a standard report, a research objective and/or one or more questions;
collecting context relevant to the query based on availability of internal information retrieval by querying the user with one or more clarification questions using one or more Artificial Intelligence (AI) agents within the MRS;
forming a strategy to retrieve data from available data sources based on the context, wherein the strategy formation comprising:
determining reliability of the available data sources and prioritizing the available data sources according to relevance of the available data sources for the research objective, the available data sources comprising non-agent sources such as web scraping, Application
Programming Interface (API) endpoints, web browsing, and uploaded files, as well as agent-based sources such as synthetic focus groups, synthetic surveys, and autonomous survey collection;
retrieving data from the available data sources based on the strategy; and
analysing the data to determine if the retrieved data is sufficient to complete the research objective;
requesting modification or additional information in the data based on the analysis using the one or more AI agents within the MRS, responsive to the data not being determined as sufficient to complete the research objective;
determining market research parameters based on the analysed data, the market research parameters comprising dynamic reports with visualizations and/or structured reports based on predefined templates; and
iteratively optimizing market research parameters by activating the one or more AI agents within the MRS based on incoming data and feedback.

2. The computer-implemented method of claim 1, wherein the internal information retrieval comprises simulating user personas and gathering insights into user preferences and behaviors.

3. The computer-implemented method of claim 2, wherein if the internal information retrieval is available, the clarification questions are provided to gather additional details to refine the research, and wherein if the internal information retrieval is not available, the clarification questions are provided to establish a baseline of the context.

4. The computer-implemented method of claim 1, further comprising adjusting the strategy formation based on feedback received from the user.

5. The computer-implemented method of claim 1, wherein the context relevant to the query comprises information about the user including target demographics, company goals, pricing strategies, and product features.

6. The computer-implemented method of claim 1, further comprising: displaying the market research parameters including the dynamic reports with the visualizations including the charts, the graphs, and the tables to convey the analysed data.

7. The computer-implemented method of claim 1, wherein the optimization of the market research parameters comprising:
iteratively finetuning the one or more AI agents within the MRS based on the data, user feedback, and predefined optimization criteria.

8. The computer-implemented method of claim 1, wherein the structured reports provided to the user are generated based on predefined templates utilizing the one or more AI agents within the MRS to fill in relevant data and analysis.

9. A computer system for automating market research, the computer system comprising:
a Market Research System (MRS) comprising:
a memory unit configured to store machine-readable instructions; and
a processor operably connected to the memory unit, the processor configured to execute the machine-readable instructions, that when executed, enable the processor to:
receive a query from a user, wherein the query comprises a standard report, a research objective and/or one or more questions;
collect context relevant to the query based on availability of internal information retrieval by querying the user with one or more clarification questions from the user using one or more Artificial Intelligence (AI) agents;
form a strategy to retrieve data based on available data sources based on the context, wherein the strategy formation comprising:
determining reliability of the available data sources and prioritize the available data sources according to their relevance of the available data sources for the research objective;
retrieve data from the available data sources based on the strategy, the available data sources comprising non-agent sources such as web scraping, Application Programming Interface (API) endpoints, web browsing, and uploaded files, as well as agent-based sources such as synthetic focus groups, synthetic surveys, and autonomous survey collection;
analyse the data to determine if the retrieved data is sufficient to complete the research objective;
request modification or additional information in the data based on the analysis using the one or more AI agents within the MRS, responsive to the data not being determined as sufficient to complete the research objective;
determine market research parameters based on the analysed data, the market research parameters comprising dynamic reports with visualizations and/or structured reports based on predefined templates; and
iteratively optimize market research parameters by activating the one or more AI agents within the MRS based on incoming data and feedback.

10. The computer-implemented method of claim 1, wherein the one or more AI agents are fine-tuned using techniques including data-driven fine-tuning, prompt engineering, parameter optimization, and self-improvement techniques such as meta-learning, transfer learning, and agent self-analyses, and wherein the iterative optimization of market research parameters incorporates Reinforcement Learning from Human Feedback (RLHF) based on user feedback.

11. The computer-implemented method of claim 1, further comprising:
extracting information from the data returned by the one or more AI agents using a chart generator agent;
selecting a chart template from a series of chart templates or using a code interpreter agent and a data visualization library to generate a custom chart; and
filling the extracted information into the selected chart template or custom chart to generate visualizations of the market research parameters.

12. The computer-implemented method of claim 1, further comprising:
generating a series of recommended prompts based on the user's market research objective, selected competitors, and other prompts; and
allowing the user to select from the recommended prompts to ask the system in a way that results in better results.

13. The computer system of claim 9, wherein for the internal information retrieval, the processor is further enabled to simulate user personas and gather insights into user preferences and behaviors.

14. The computer system of claim 10, wherein if the internal information retrieval is available, the clarification questions are provided to gather additional details to refine the research, and wherein if the internal information retrieval is not available, the clarification questions are provided to establish a baseline of the context.

15. The computer system of claim 9, the processor is further enabled to adjust the strategy formation based on feedback received from the user.

16. The computer system of claim 9, wherein the context relevant to the query comprises information about the user including target demographics, company goals, pricing strategies, and product features.

17. The computer system of claim 9, the processor is further enabled to display the market research parameters including the dynamic reports with the visualizations including the charts, the graphs, and the tables to convey the analysed data.

18. The computer system of claim 9, wherein to optimize the market research parameters, the processor is further enabled to:
iteratively finetune the one or more AI agents within the MRS based on the data, user feedback, and predefined optimization criteria.

19. The computer system of claim 9, wherein the structured reports provided to the user are generated based on predefined templates utilizing the one or more AI agents within the MRS to fill in relevant data and analysis.

20. A non-transitory computer-readable storage medium storing computer-executable instructions which when executed by a computer system causes the computer system to:
receive a query from a user within a Market Research System (MRS), wherein the query comprises standard report, a research objective and/or one or more questions;
collect context relevant to the query, based on availability of internal information retrieval by querying the user with one or more clarification questions using one or more Artificial Intelligence (AI) agents;
form a strategy to retrieve data based on available data sources based on the context, wherein the strategy formation comprising:
determining reliability of the available data sources and prioritize the available data sources according to relevance of the available data sources for the research objective;
retrieve data from the available data sources based on the strategy, the available data sources comprising non-agent sources such as web scraping, Application Programming Interface (API) endpoints, web browsing, and uploaded files, as well as agent-based sources such as synthetic focus groups, synthetic surveys, and autonomous survey collection;
analyse the data to determine if the retrieved data is sufficient to complete the research objective;
request modification or additional information in the data based on the analysis using the one or more AI agents within the MRS, responsive to the data not being determined as sufficient to complete the research objective;
determine market research parameters based on the analysed data, the market research parameters comprising dynamic reports with visualizations and/or structured reports based on predefined templates; and
iteratively optimize market research parameters by activating the one or more AI agents within the MRS based on incoming data and feedback.

21. The non-transitory computer-readable storage medium of claim 17, wherein for the internal information retrieval, the computer-executable instructions are further enabled to simulate user personas and gather insights into user preferences and behaviors.

22. The non-transitory computer-readable storage medium of claim 17, the computer-executable instructions are further enabled to adjust the strategy formation based on feedback received from the user.

23. The non-transitory computer-readable storage medium of claim 17, wherein if the internal information retrieval is available, the clarification questions are provided to gather additional details to refine the research, and wherein if the internal information retrieval is not available, the clarification questions are provided to establish a baseline of the context.
